(19) United States
(12) Patent Application Publication
(10) Pub. No.: US 2009/0102764 A1
(43) Pub. Date: Apr. 23, 2009

(54) Liquid Crystal Display and Driving Method Therefor

(75) Inventors: Ken-Ming Chen, Hsinchu (TW); Ming-Jong Jou, Hsinchu (TW); Chi-Mao Hung, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/181,017

(22) Filed: Jul. 28, 2008

(30) Foreign Application Priority Data
Oct. 19, 2007 (TW) 96139579
Apr. 3, 2008 (TW) 97112144

(51) Int. Cl. G09G 3/36

(52) U.S. Cl. 345/87; 345/98

(57) ABSTRACT

A liquid crystal display is provided. The liquid crystal display includes a substrate, a plurality of data lines, a plurality of gate lines, a gate driving circuit, and a source driving circuit. The substrate includes a pixel array including a plurality of pixels arranged as a matrix. The data lines are electrically connected to the pixel array. The gate lines are electrically connected to the pixel array and include a plurality of odd-numbered gate lines and a plurality of even-numbered gate lines, wherein one of the odd-numbered gate lines and one of the even-numbered gate lines are electrically connected to the pixels located in the same row. The gate driving circuit includes a first gate driving circuit and a second gate driving circuit, wherein the first gate driving circuit is electrically connected to the odd-numbered gate lines and the second gate driving circuit is electrically connected to the even-numbered gate lines. The source driving circuit is electrically connected to the data lines.

### CROSS-REFERENCES TO RELATED APPLICATIONS

This application claims priority to Taiwan Patent Applications No. 096139579 filed on Oct. 19, 2007, and No. 097112144 filed on Apr. 3, 2008, the latter of which is incorporated herein by reference in its entirety.

### BACKGROUND OF THE INVENTION

1. Field of the Invention

The present invention relates to a liquid crystal display. More particularly, the present invention relates to a pixel structure of a liquid crystal display (LCD) and a driving method thereof.

2. Descriptions of the Related Art

The evolvement of display technologies has led to the gradual elimination of conventional cathode ray tube (CRT) displays. Nowadays, displays, such as liquid crystal displays (LCDs) and plasma displays, are more lightweight, thinner, and power saving, and have gradually become mainstream products in the display market. In addition, with the development of LCD technologies, a variety of variations such as the dual view display, the 3D display or the like have been proposed, and accordingly, more and more research efforts are directed on such products.

FIG. 1 is a schematic view of a pixel structure of a conventional 3D display. As depicted in FIG. 1, the 3D display 10 comprises a gate driving circuit 101, a source driving circuit 102, and a plurality of pixels 103 arranged in matrix. By using a particular pixel layout and various film materials, the display can be made in such a way that when a user is viewing the display, an image displayed by pixels in odd-numbered columns is only visible to the left eye while that displayed by pixels in even-numbered columns is only visible to the right eye. As a result, a stereoscopic displaying effect can be achieved.

FIG. 2 illustrates a block diagram of the driving architecture of a conventional 3D display. The driving architecture comprises a first input source 201, a second input source 202, a time sequence controlling integrated circuit (IC) 204, a synchronous dynamic random access memory (SDRAM) 205 and a source driving circuit 102. Conventionally, the data transmitted to the pixels in odd-numbered columns and those transmitted to pixels in the even-numbered columns are provided by two different input sources. To synchronize the data transmitted from the different input sources with each other, the SDRAM 205 is needed as a frame memory to store the data transmitted from the first input source 201 and the second input source 202. Despite the stereoscopic displaying effect, this driving architecture has the following disadvantages: (1) the expensive SDRAM raises the cost of the product; and (2) since an SDRAM is needed to store and access data, more control signals are required for the time sequence controlling IC 204, which adds complexity to the control circuit. Similar to the 3D displays, conventional dual view displays also require the SDRAM as the frame memory, thus raising costs and adding complexity of control signals as well.

Many challenges still have to be overcome in the design and manufacture of 3D displays and dual view displays. Accordingly, efforts still have to be made in the art to decrease the complexity of the circuit design and reduce the costs.

### SUMMARY OF THE INVENTION

One objective of this invention is to provide a liquid crystal display (LCD), which comprises a substrate, a plurality of data lines, a plurality of gate lines, a first gate driving circuit, a second gate driving circuit and a source driving circuit. The substrate comprises a pixel array, which comprises a plurality of pixels arranged as a matrix. The data lines are electrically connected to the pixel array. The gate lines, which comprise a plurality of odd-numbered gate lines and a plurality of even-numbered gate lines, are electrically connected to the pixel array, wherein one of the odd-numbered gate lines and one of the even-numbered gate lines are electrically connected to the pixels located in the same row. The first gate driving circuit is electrically connected to the odd-numbered gate lines, the second gate driving circuit is electrically connected to the even-numbered gate lines, and the source driving circuit is electrically connected to the data lines.

Another objective of this invention is to provide a driving method for a liquid crystal display. The liquid crystal display comprises a pixel array. The driving method comprises the following steps: receiving the first data signal; enabling the first pixel row; transmitting the first data signal to a plurality of odd-numbered pixels of the first pixel row; receiving the second data signal; enabling the second pixel row; and transmitting the second data signal to a plurality of even-numbered pixels of the second pixel row.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a pixel structure according to a conventional 3D display;

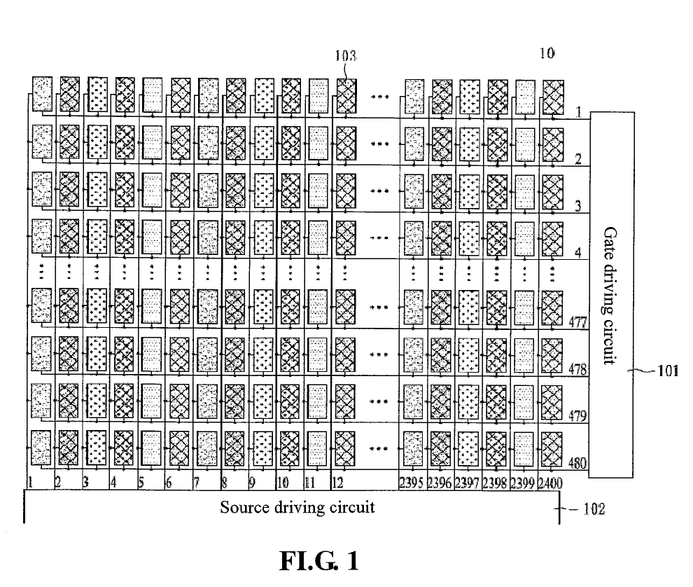

FIG. 2 is a block diagram of a driving architecture according to a conventional 3D display;

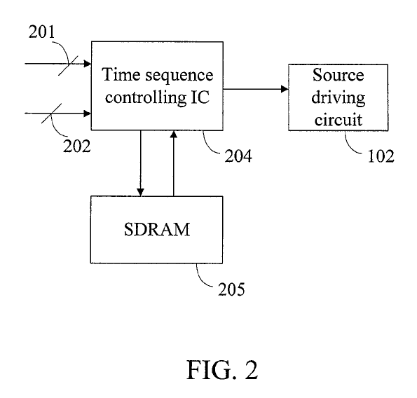

FIG. 3 is a schematic view of a pixel structure of an LCD, according to the present invention;

FIG. 4 illustrates a block diagram of a driving architecture for an LCD, according to the present invention;

FIG. 5 illustrates the time sequence of a gate driving signal for an LCD, according to the present invention; and

FIG. 6 is a flow diagram of a driving method for an LCD, according to the present invention.

### DESCRIPTION OF THE PREFERRED EMBODIMENT

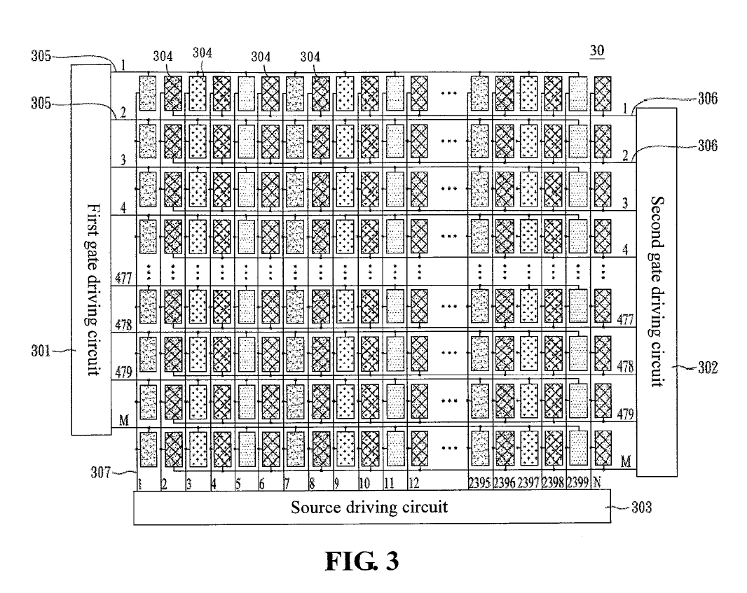

FIG. 3 illustrates an embodiment of an LCD according to this invention. The LCD 30 comprises a first gate driving circuit 301, a second gate driving circuit 302, a source driving circuit 303, a plurality of pixels 304 arranged as a matrix, M first gate lines 305 arranged in a row direction and parallel to each other, and M second gate lines 306 arranged in the row direction and parallel to each other, where M is a positive integer. The first gate lines 305 and the second gate lines 306 may be, for example, odd-numbered gate lines and even-numbered gate lines respectively. The first gate lines 305 are electrically connected to the first gate driving circuit 301, while the second gate lines 306 are electrically connected to the second gate driving circuit 302. The first gate driving circuit 301 and the second gate driving circuit 302 are configured to enable the first gate lines 305 and the second gate lines 306 respectively. The first gate driving circuit 301 is electrically connected to the first gate lines 305, while the second gate driving circuit 302 is electrically connected to the second gate lines 306. The LCD 30 further comprises N data lines 307 arranged in a column direction and parallel to each other, where N is a positive integer. The source driving circuit 303 is electrically connected to the data lines 307 to supply data signals to the data lines 307. Additionally, the data lines 307 are substantially perpendicular to the gate lines 305 and 306.

In this embodiment, the pixels 304 in the odd-numbered column of a same row are electrically connected to the corresponding first gate line 305, while pixels 304 in the even-numbered columns of a same row are electrically connected to a corresponding second gate line 306. In a conventional pixel connection scheme, pixels in the same row are all controlled by a single gate driving circuit. In other words, pixels in the same row can only be all enabled or all disabled at the same time. In contrast, with the pixel layout of this invention, the odd-numbered pixels and even-numbered pixels in the same row can be enabled respectively at different times, thereby decreasing the complexity of the circuit design and reducing the costs. It should be noted that, although the example in which a row of pixels are divided into odd-numbered pixels and even-numbered pixels for control respectively is illustrated in this embodiment, this invention is not limited thereto, i.e., the manner in which the pixels are divided may vary according to the practical design. For example, every two or more adjacent pixels may be used as a basic unit for control.

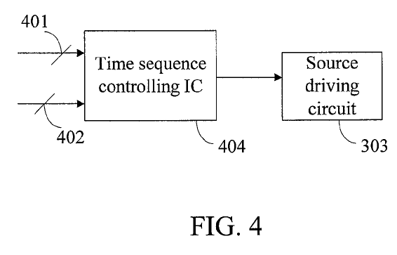

FIG. 4 illustrates a block diagram of the driving architecture of an embodiment of the LCD according to this invention. The driving architecture comprises a first input source 401, a second input source 402, a time sequence controlling IC 404 and a source driving circuit 303. The first input source 401 and the second input source 402 are configured to transmit the first data signal (SOURCE_1 input) and the second data signal (SOURCE_2 input) respectively to the time sequence controlling IC 404, which then transmits the first data signal and the second data signal to the source driving circuit 303 in sequence. More specifically, the first data signal and the second data signal are transmitted to the odd-numbered data lines and even-numbered data lines respectively. As shown in FIG. 3, when the first gate line 305 is enabled by the first gate driving circuit 301, the source driving circuit 303 transmits the corresponding first data signal to the odd-numbered data lines. On the other hand, when the second gate line 306 is enabled by the second gate driving circuit 302, the source driving circuit 303 transmits the corresponding second data signal to the even-numbered data lines. In other words, the first gate lines 305 and the second gate lines 306 are able to receive the first data signal and the second data signal respectively during the enabled time.

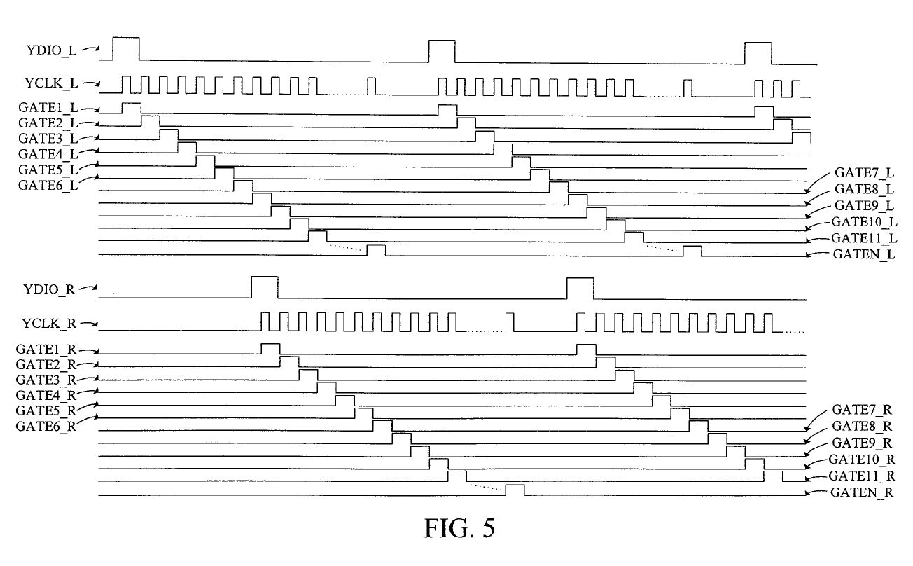

FIG. 5 illustrates the time sequence of the gate driving signals in an embodiment of an LCD of this invention. With reference to both FIG. 3 and FIG. 5, upon receiving the start signal YDIO_L, the first gate driving circuit 301 transmits enabling signals GATE1_L, GATE2_L, . . . , GATEN_L to the M first gate lines 305 in a sequence corresponding to the clock signal YCLK_L. Upon receiving a start signal YDIO_R, the second gate driving circuit 302 transmits enabling signals GATE1_R, GATE2_R, . . . , GATEN_R to the M second gate lines 306 in a sequence corresponding to the clock signal YCLK_R. It should be noted that the transmissions of the starting signals for the first gate driving circuit 301 and the second gate driving circuit 302 are not limited to a particular order, but may vary according to the practical design. Similarly, the transmissions of the enabling signals are not limited to a particular order, but may vary according to the practical design. For example, the first gate driving circuit 301 and the second gate driving circuit 302 may enable the first gate lines 305 and the second gate lines 306 alternately. Alternatively, the first gate lines 305 may be enabled first and then followed by enabling the second gate lines 306. The second gate lines 306 may also be enabled first and then followed by the enabling of the first gate lines 305. During the time period when one of the first gate lines 305 is enabled, the source driving circuit 303 transmits the first data signal to the enabled first gate line. Likewise, during the time period when one of the second gate lines 306 is enabled, the source driving circuit 303 transmits the second data signal to the enabled second gate line. As a result, the odd-numbered columns and the even-numbered columns of the pixel array will display images corresponding to the first data signal and the second data signal respectively, thus achieving a stereoscopic or a dual view displaying effect. Furthermore, in this architecture, it is unnecessary to store the first data signal and the second data signal in an SDRAM or a similar memory, so the use of the SDRAM or a similar memory is eliminated. As a result, the costs, as well as the complexity, are reduced.

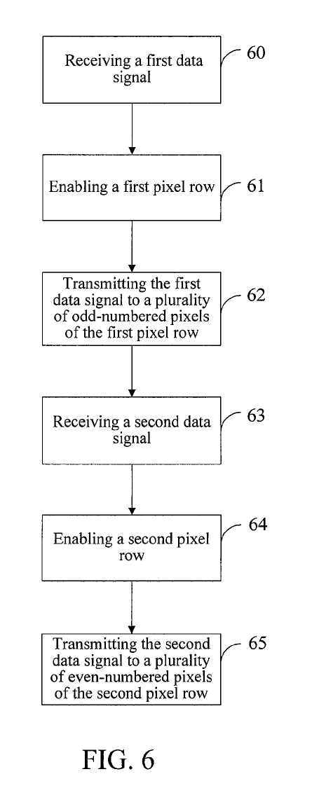

FIG. 6 is a flow diagram of the driving method for an LCD of this invention. The LCD comprises a pixel array, while the driving method comprises: receiving the first data signal (step 60); enabling the first pixel row (step 61); transmitting the first data signal to a plurality of odd-numbered pixels of the first pixel row (step 62); receiving the second data signal (step 63); enabling the second pixel row (step 64); and transmitting the second data signal to a plurality of even-numbered pixels of the second pixel row (step 65). By repeating the above steps, all the odd-numbered pixels in the pixel array will receive the first data signal, and all the even-numbered pixels in the pixel array will receive the second data signal. Consequently, the odd-numbered pixels display the first frame corresponding to the first data signal, while the even-numbered pixels display the second frame corresponding to the second data signal. Then, by using various film materials, the first frame and the second frame come into the left eye and the right eye respectively, thus achieving a stereoscopic or a dual view displaying effect. In this method, it is unnecessary to store the first data signal and the second data signal into an SDRAM or a similar memory, so the use of the SDRAM or a similar memory is eliminated. As a result, costs and design complexity are reduced.

In all the above embodiments, the gate driving circuit may be implemented by a conventional shift register or other circuits with similar functions, and thus will not be further described herein.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A liquid crystal display comprising:
a substrate comprising a pixel array having a plurality of pixels arranged as a matrix;
a plurality of data lines electrically connected to the pixel array;
a plurality of gate lines electrically connected to the pixel array, the gate lines comprising a plurality of odd-numbered gate lines and a plurality of even-numbered gate lines, wherein one of the odd-numbered gate lines and one of the even-numbered gate lines are electrically connected to the pixels located in the same row;
a first gate driving circuit electrically connected to the odd-numbered gate lines and configured to enable the odd-numbered gate lines to receive a first data signal during an enabled time period;
a second gate driving circuit electrically connected to the even-numbered gate lines and configured to enable the even-numbered gate lines to receive a second data signal during an enabled time period; and
a source driving circuit electrically connected to the data lines and configured to transmit the data signal.

2. The liquid crystal display as claimed in claim 1, wherein the first gate driving circuit is configured to enable the odd-numbered gate lines in sequence.

3. The liquid crystal display as claimed in claim 2, wherein the second gate driving circuit is configured to enable the even-numbered gate lines in sequence.

4. The liquid crystal display as claimed in claim 3, wherein the source driving circuit is configured to transmit at least one data signal to the data lines.

5. The liquid crystal display as claimed in claim 3, wherein the first gate driving circuit and the second gate driving circuit are configured to alternately enable the odd-numbered gate lines and the even-numbered gate lines.

6. The liquid crystal display as claimed in claim 4 further comprising a time sequence controller configured to receive the first data signal and the second data signal, wherein the source driving circuit is configured to transmit the first data signal and the second data signal to the data lines.

7. The liquid crystal display as claimed in claim 1, wherein one of the odd-numbered gate lines is electrically connected to the odd-numbered column pixels which are located in the same row.

8. The liquid crystal displays as claimed in claim 1, wherein one of the even-numbered gate lines is electrically connected to the even-numbered column pixels which are located in the same row.

9. A driving method for a liquid crystal display, the liquid crystal display comprising a pixel array having a plurality of pixel rows, the driving method comprising:
receiving a first data signal;
enabling a first pixel row, the first pixel row comprising a plurality of pixels;
transmitting the first data signal to a plurality of odd-numbered pixels of the first pixel row;
receiving a second data signal;
enabling a second pixel row, the second pixel row comprising a plurality of pixels; and
transmitting the second data signal to a plurality of even-numbered pixels of the second pixel row.

10. The driving method as claimed in claim 9, wherein receiving the first data signal is prior to receiving the second data signal.
